(19) United States
(12) Patent Application Publication
(10) Pub. No.: US 2007/0248026 A1
(43) Pub. Date: Oct. 25, 2007

(54) System, Method, and Computer Program Product for Concept Network Based Collaboration

(75) Inventor: Charles E. Bess, McKinney, TX (US)

Correspondence Address: DOCKET CLERK, DM/EDS, P.O. DRAWER 800889, DALLAS, TX, 75380, US

(73) Assignee: Electronic Data Systems Corporation, Plano, TX (US)

(21) Appl. No.: 11/379,342

(22) Filed: Apr. 19, 2006

(51) Int. Cl. H04L 12/28

(52) U.S. Cl. 370/254

(57) ABSTRACT

A method including steps of receiving a first concept network having a plurality of connected nodes; receiving a second concept network having a plurality of connected nodes; and generating a third concept network, the third concept network having a plurality of connected nodes being a combination of the first and second concept networks. Related systems and computer program products are also included.

### TECHNICAL FIELD OF THE INVENTION

The present invention is directed, in general, to computer-assisted collaboration techniques.

### BACKGROUND OF THE INVENTION

When problem-solving or innovating, persons working alone often develop an understanding of a problem from a limited perspective. It is often useful to bounce ideas off others and incorporate their perspective. Unfortunately, distance and scheduling issues often prevent people from meeting face-to-face to collaborate and compare mental models to identify commonalities and contrasting views.

There is, therefore, a need in the art for a system, method, and computer program product for comparing and overlaying different conceptual networks to identify common and divergent patterns.

### SUMMARY OF THE INVENTION

To address the above-discussed deficiencies of the prior art, a disclosed embodiment provides method including steps of receiving a first concept network having a plurality of connected nodes and receiving a second concept network having a plurality of connected nodes. The method also includes generating a third concept network, the third concept network having a plurality of connected nodes being a combination of the first and second concept networks.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a data processing system in which a disclosed embodiment can be implemented;

FIG. 2 depicts a block diagram of a data processing system network in which an embodiment of the present invention can be implemented;

FIGS. 3A-3E depict a series of exemplary concept networks as two different concept networks are combined, in accordance with an embodiment of the present invention;

FIG. 4 depicts an exemplary data structure for a concept node for implementing a concept network in accordance with a disclosed embodiment; and

FIG. 5 depicts a flowchart of a process in accordance with a preferred embodiment.

### DETAILED DESCRIPTION OF THE INVENTION

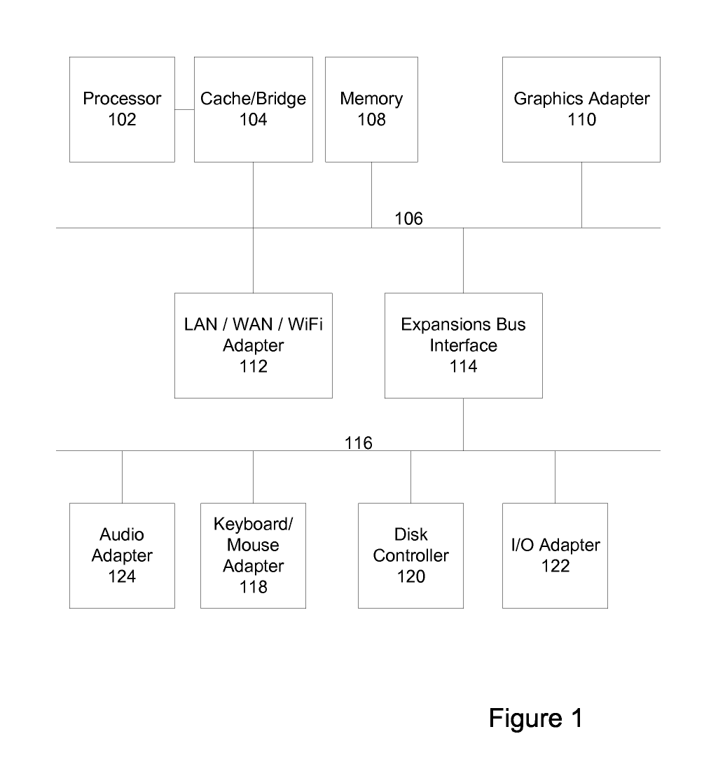

FIGS. 1 through 5, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

A concept network (or conceptual network) is a technique for visualizing relationships between concepts or objects. In a typical concept network, a number of nodes are defined, and relationships between the nodes are defined. A network is then formed by the collection of nodes connected by relationship links. While concept networks are known, there is not a known means for individuals to jointly develop a concept network from different locations in a collaborative fashion. There is also no automated way for multiple concept networks to be combined to identify common and divergent patterns.

Various embodiments include a system, method, and computer program product that can be used by individuals who are geographically diverse to be able to benefit from the conceptual relationships identified by others. With a geographically diverse workforce, enabling the improved flow of ideas without having to synchronize schedules is a significant advantage of the disclosed embodiments.

The disclosed embodiments enable individuals to create their own concept network (e.g., Animal→Pet→Dog) and relate it to other people's concept networks (e.g., Pet→Cat). For example, a taxonomy concept network of a first person may include nodes of “Animal” linked to “Pet” linked to “Dog”. A similar taxonomy concept network of another person may include nodes of “Pet” linked to “Cat”. By combining these concept networks, both persons are able to see an additional relationship they had not previously considered.

Of course, although this example is a taxonomy concept network, the disclosed embodiments are not limited to hierarchical relationships. The disclosed embodiments provide means for creating the concept networks. Using word comparison or other semantic tools, the concept networks of one individual can be combined with the concept networks of others. This relationship can be displayed via an overlay using color coding, bolding or other multi-dimensional display techniques. Systems that use taxonomies instead of networks to store their information can be combined with other concept networks or taxonomies as well.

FIG. 1 depicts a block diagram of a data processing system in which a disclosed embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular. For example, other peripheral devices, such as an optical disk drive and the like, also may be used in addition or in place of the hardware depicted. The depicted example is provided for the purpose of explanation only and is not meant to imply architectural limitations with respect to the present invention.

A data processing system in accordance with a preferred embodiment of the present invention includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of MICROSOFT WINDOWS™, a product of Microsoft Corporation located in Redmond, Wash. may be employed if suitably modified. The operating system is modified or created in accordance with the present invention as described.

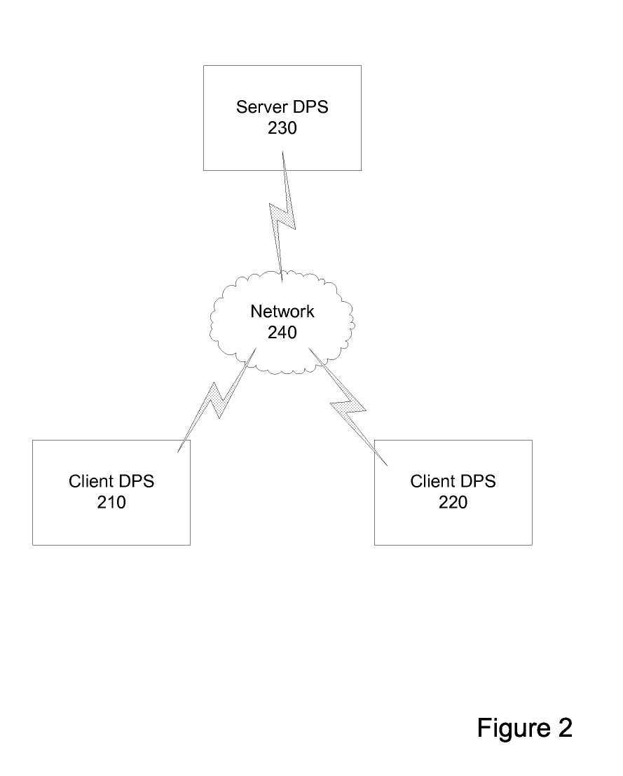

FIG. 2 depicts a block diagram of a data processing system network in which an embodiment of the present invention can be implemented. Shown here are client data processing systems 210 and 220, and server data processing system 230, all connected to communicate via network 240, using known network communication techniques. Data processing systems 210, 220, and 230 can each be implemented as data processing system 100 shown in FIG. 1, or can be modified, as known to those of skill in the art, as necessary for a particular implementation. Network 240 can be a public or private network, or combination of these, including the Internet, so long as it can provide communications between the data processing systems shown, as will be described below.

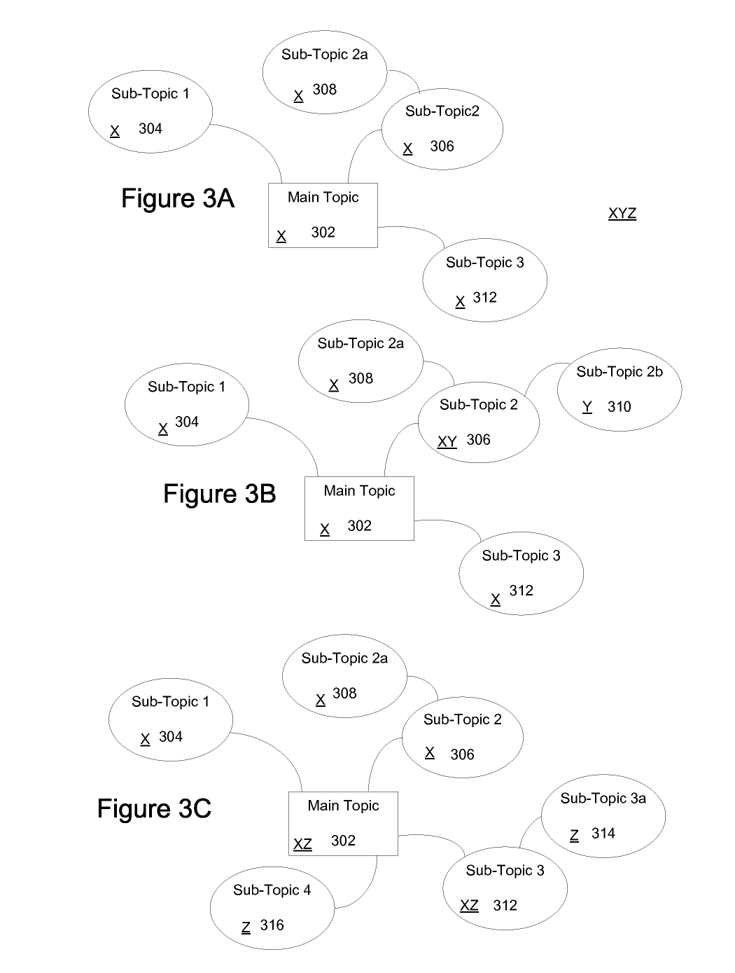

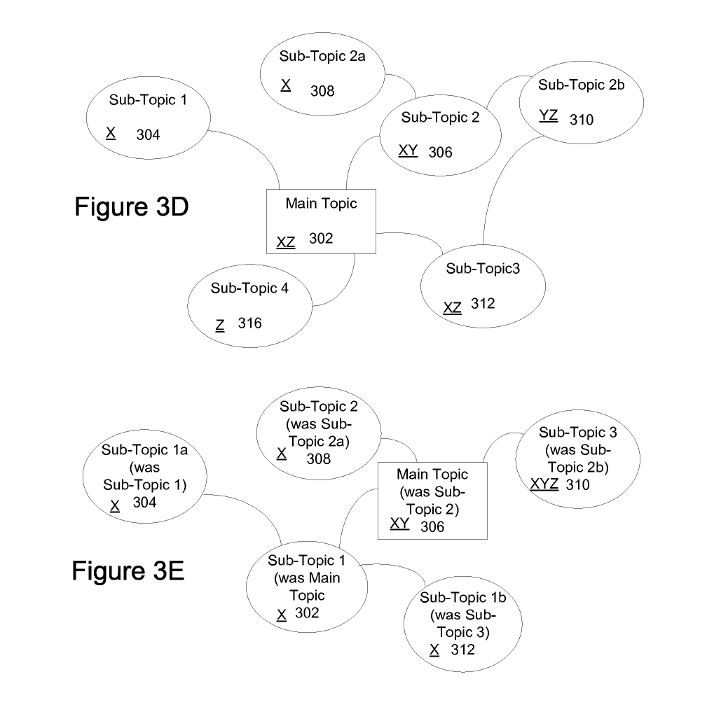

FIGS. 3A-3E depict a series of exemplary concept networks as two different concept networks are combined, in accordance with an embodiment of the present invention. In a preferred implementation, the objects depicted in the concept networks are differentiated by color, in order to make the visualizations of the interaction and overlaps of different concept networks clear. The limitations of this patent document and accompanying figures prevent color illustrations, so letters X, Y, and Z are used to identify those elements that form a part of first, second, and third concept networks, respectively. In various implementations, other means of visually distinguishing the various concept networks can be used, as will be apparent to those of skill in the art.

FIG. 3A depicts an exemplary first concept network, identified with an “X” reference, as may be created by a first user or system. FIG. 3A depicts a first user's concept network for “Anniversary Ideas.” For example, the main topic 302 may be “anniversary” with the sub-topic 1 (304) being “movie,” subtopic 2 (306) being “travel”, and sub-topic 3 being “dinner” (312). Sub-topic 2 (306) “travel” can have a further sub-topic 2a (308) of “Carribean”.

FIG. 3B depicts the exemplary first concept network of FIG. 3A overlaying a second concept network from a second user, identified with an “Y” reference, for example the spouse of the first user, also related to Anniversary Ideas. The second user's concept network also includes an interest in travel, as indicated by the “Y” indicator in subtopic 2 (306), but instead of sub-topic 2a (308) of “Carribean”, indicates sub-topic 2b (310) of “Italy”.

FIG. 3C depicts the exemplary first concept network of FIG. 3A overlaying a third concept network from a third source, identified with an “Z” reference, for example an Internet website related to anniversary ideas, as in main topic 302. The website includes a taxonomy on anniversary ideas, and includes sub-topic 3 “dinner” (312), but the website suggests that Italian is more romantic and is ideal for anniversaries, as sub-topic 3a “Italian” (314). The website may also suggest that going on a cruise, sub-topic 4 (316) is the ideal wedding anniversary gift.

FIG. 3D depicts the overlay of the first, second, and third concept networks. shows that there may be a linkage between my wife's idea of going to Italy at sub-topic 2b (310) and the Italian food concept at subtopic 3a (314). This can linkage can be identified by the user, or by a the system using semantic analysis which combines “Italy” in 310 with “Italian” in 314, and displays simply one combined block, sub-topic 2b “Italy” (310). This linkage is readily visible when all three concept networks are overlaid.

FIG. 3E illustrates a feature of the system to move the focus from the old main topic 302 of “anniversary” to a new main topic 306, “travel”, which was formerly sub-topic 2. As can be seen, previous main topic (302) becomes sub-topic 1, previous sub-topic 1 (304) becomes sub-topic 1a, previous sub-topic 2a (308) becomes sub-topic 2, previous sub-topic 2b (310) becomes sub-topic 3, and previous sub-topic 3 (312) becomes sub-topic 1b. In this way, when the new main topic becomes the “focus” of the concept networks (or combination of concept networks), the system can automatically re-designate each other node as relates to the main topic node.

Particular features of various embodiments can vary as needed or advantageous for particular implementations. Some disclosed embodiments include automatic identification of overlapping concept nodes, using direct comparison, synonyms, and other semantic analysis, which can be performed on a single data processing system or remotely over a computer network. Some disclosed embodiments include the ability to display to a user any overlapping and related nodes on an existing concept network when combined with or overlaid by other concept networks. Some disclosed embodiments include the ability to display additional nodes or linkages on an existing concept network when compared with or overlaid by other concept networks from local or remote sources, allowing for the extension of the existing network.

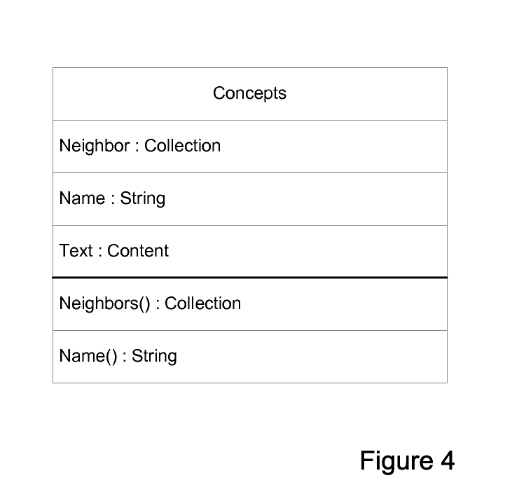

In some disclosed embodiments, the concept networks are stored in the host data processing systems using a network of linked lists connecting concept nodes. FIG. 4 depicts an exemplary data structure for a concept node for implementing a concept network in accordance with a disclosed embodiment.

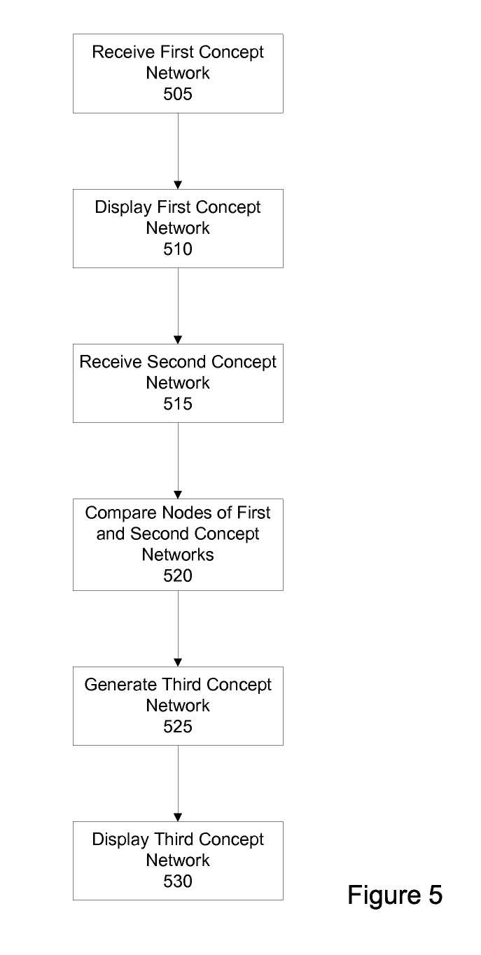

FIG. 5 depicts a flowchart of a process in accordance with a preferred embodiment.

A first data processing system receives a first concept network having a plurality of connected nodes (step 505). Here, the first data processing system can be one of client data processing system 210/220, or can be server data processing system 230, any of which can be implemented as described with relation to FIG. 1. “Receive” can include loading the concept network from a storage, receiving a concept network over network 240 from another data processing system, or receiving it as interactively created by a user. The means for receiving, therefore, can include adapter 112, I/O bus 116, and other part of a data processing system as data processing system 100.

The first data processing system will display the first concept network (step 510). Note that in the case where the first data processing system is a server data processing system being accessed remotely by a client data processing system, this step can be satisfied by sending data to the client data processing system to be displayed on the client data processing system.

The first data processing receives a second concept network having a plurality of connected nodes (step 515). “Receive” can include loading the concept network from a storage, receiving a concept network over network 240 from another data processing system, or receiving it as interactively created by a user. In this way, the first and second concept networks can be created and edited asynchronously, or can be concurrently developed, then combined or manipulated as described herein. The first and second concept networks can be created by different users on different data processing systems, or can be generated, for example, from a stored database or taxonomy.

The first data processing system then compares the nodes of the first concept network and the second concept network (step 520). This comparison is done using literal string comparison, word root comparisons, and other semantic analysis to identify nodes that relate to concepts that are identical or significantly related. Such semantic analysis techniques are known to those of skill in the art, and are commonly employed, for example, in parsing Internet search engine queries.

The first data processing system then generates a third concept network (step 525), which is a combination of the first concept network and the second concept network. Preferably, any nodes that relate to concepts that are identical or significantly related are combined into a single node, including all of the links to other nodes. Preferably, each node includes an identification as to whether it was originally part of the first concept network, the second concept network, or both. This generating and for other processing tasks described herein can be performed by means such as a processor 102 and others.

The first data processing system will then display the third concept network (step 530). Preferably, each node is displayed in such as was so as to be identifiable by a user as being originally part of the first concept network, the second concept network, or both. In this way, the common and divergent concepts of each of the first and second concept networks can be readily identified. Note again that in the case where the first data processing system is a server data processing system being accessed remotely by a client data processing system, this step can be satisfied by sending data to the client data processing system to be displayed on the client data processing system. Each node of the third concept network preferably can be visually identified as corresponding to one or both of the first concept network and the second concept network

In a preferred embodiment, each of the concept networks described herein is stored in a data processing storage using a network of doubly-linked lists, with nodes defined by data structures as shown in FIG. 4.

In various embodiments, any of the first, second, or third concept networks can be independently displayed or edited at any time after being received or created. Further, although only a combination of first and second concept networks is described in the above example, those of skill in the art will recognize that any number of concept networks can be combined in the manner described herein.

One known technique related to some issues disclosed herein is described in U.S. Pat. No. 6,256,032, which is hereby incorporated by reference.

Those skilled in the art will recognize that, for simplicity and clarity, the full structure and operation of all data processing systems suitable for use with the present invention is not being depicted or described herein. Instead, only so much of a data processing system as is unique to the present invention or necessary for an understanding of the present invention is depicted and described. The remainder of the construction and operation of data processing system 100 may conform to any of the various current implementations and practices known in the art.

It is important to note that while the present invention has been described in the context of a fully functional system, those skilled in the art will appreciate that at least portions of the mechanism of the present invention are capable of being distributed in the form of instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

What is claimed is:

1. A method, comprising:
receiving a first concept network having a plurality of connected nodes;
receiving a second concept network having a plurality of connected nodes; and
generating a third concept network, the third concept network having a plurality of connected nodes being a combination of the first and second concept networks.

2. The method of claim 1, further comprising comparing the nodes of the first concept network with the nodes of the second concept network.

3. The method of claim 2, wherein the comparison is performed using semantic analysis techniques.

4. The method of claim 1, wherein the first concept network and the second concept network are created by different users on different data processing systems.

5. The method of claim 1, further comprising displaying the third concept network.

6. The method of claim 1, wherein each node of the third concept network can be visually identified as corresponding to one or both of the first concept network and the second concept network.

7. The method of claim 1, wherein each of the nodes is stored as an entry in a doubly-linked list.

8. A data processing system having at least a processor and accessible memory, comprising:
means for receiving a first concept network having a plurality of connected nodes;
means for receiving a second concept network having a plurality of connected nodes; and
means for generating a third concept network, the third concept network having a plurality of connected nodes being a combination of the first and second concept networks.

9. The data processing system of claim 8, further comprising means for comparing the nodes of the first concept network with the nodes of the second concept network.

10. The data processing system of claim 9, wherein the comparison is performed using semantic analysis techniques.

11. The data processing system of claim 8, wherein the first concept network and the second concept network are created by different users on different data processing systems.

12. The data processing system of claim 8, further comprising means for displaying the third concept network.

13. The data processing system of claim 8, wherein each node of the third concept network can be visually identified as corresponding to one or both of the first concept network and the second concept network.

14. The data processing system of claim 8, wherein each of the nodes is stored as an entry in a doubly-linked list in the data processing system.

15. A computer program product tangibly embodied in a machine usable medium, comprising:
instructions for receiving a first concept network having a plurality of connected nodes;
instructions for receiving a second concept network having a plurality of connected nodes; and
instructions for generating a third concept network, the third concept network having a plurality of connected nodes being a combination of the first and second concept networks.

16. The computer program product of claim 15, further comprising instructions for comparing the nodes of the first concept network with the nodes of the second concept network.

17. The computer program product of claim 16, wherein the comparison is performed using semantic analysis techniques.

18. The computer program product of claim 15, wherein the first concept network and the second concept network are created by different users on different data processing systems.

19. The computer program product of claim 15, further comprising instructions for displaying the third concept network.

20. The computer program product of claim 15, wherein each node of the third concept network can be visually identified as corresponding to one or both of the first concept network and the second concept network.

21. The computer program product of claim 15, wherein each of the nodes is stored as an entry in a doubly-linked list.
